(19) United States
(12) Patent Application Publication
(10) Pub. No.: US 2026/0142402 A1
(43) Pub. Date: May 21, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Shinji TANAKA, Mie (JP)

(21) Appl. No.: 19/119,405

(22) PCT Filed: Sep. 25, 2023
(86) PCT No.: PCT/JP2023/034681

§ 371 Date: Apr. 9, 2025

(30) Foreign Application Priority Data
Oct. 14, 2022 (JP) 2022-165378

(51) Int. Cl. H01R 13/502

(52) U.S. Cl. CPC H01R 13/502

(57) ABSTRACT

A connector includes a first housing including a terminal accommodating portion formed with a terminal accommodation hole and a wire accommodating portion, and a second housing to be united with the first housing. The terminal accommodating portion and the wire accommodating portion are formed with a work opening. An outer end part of the wire accommodating portion is formed with a wire pull-out opening. The second housing includes a lid portion for closing the work opening and a wire guiding end portion for guiding a wire outside the wire pull-out opening. An elastic ring arranged obliquely to an extension direction of the wire accommodating portion to be located closer to the terminal accommodating portion than the work opening and the wire pull-out opening is interposed between the first housing and the second housing.

### TECHNICAL FIELD

The present disclosure relates to a connector.

### BACKGROUND

Patent Document 1 discloses a housing of a connector provided with a first housing element, in which connector-side terminals are mounted, and a second housing element. The first housing element is provided with an opening used as an insertion opening when the connector-side terminals are mounted, and the second housing element is united with the first housing element to close this opening.

### PRIOR ART DOCUMENT

### Patent Document

Patent Document 1: JP 2008-288116 A

### SUMMARY OF THE INVENTION

### Problems to be Solved

According to the connector disclosed in Patent Document 1, it is assumed that wires extending from the connector-side terminals are largely pulled out from the opening when the connector-side terminals are inserted into the first housing element. Thus, it is assumed that the pulled-out wires are largely pulled back into the first housing element to prevent interference with the housing when the second housing element is united with the first housing element, and a housing uniting operation becomes cumbersome.

Accordingly, the present disclosure aims to easily perform a uniting operation of a first housing including a terminal accommodating portion and a second housing for closing a work opening of the first housing and enable easy realization of water cut-off between the first and second housings.

### Means to Solve the Problem

The present disclosure is directed to a connector having a wire pulled out in a direction intersecting an extension direction of a terminal, the connector being provided with a first housing including a terminal accommodating portion formed with a terminal accommodation hole, the terminal being mounted into the terminal accommodation hole, and a wire accommodating portion extending outward from a part of an outer periphery of the terminal accommodating portion, and a second housing to be united with the first housing, the terminal accommodating portion and the wire accommodating portion being formed with a work opening open on a front side in a mounting direction of the terminal into the terminal accommodation hole, an outer end part of the wire accommodating portion being formed with a wire pull-out opening continuous with the work opening, the second housing including a lid portion for closing the work opening and a wire guiding end portion for guiding the wire pulled out from the terminal via the wire accommodating portion outside the wire pull-out opening, and an elastic ring arranged obliquely to an extension direction of the wire accommodating portion to be located closer to the terminal accommodating portion than the work opening and the wire pull-out opening being interposed between the first housing and the second housing.

### Effect of the Invention

According to the present disclosure, it is possible to easily perform a uniting operation of a first housing including a terminal accommodating portion and a second housing for closing a work opening of the first housing and enable easy realization of water cut-off between the first and second housings.

### BRIEF DESCRIPTION OF THE DRAWINGS

FIG. 1 is a perspective view showing a connector according to an embodiment.

FIG. 2 is a perspective view showing the connector according to the embodiment.

FIG. 3 is an exploded perspective view showing the connector.

FIG. 4 is an exploded perspective view showing the connector.

FIG. 5 is a section along V-V of FIG. 1.

FIG. 6 is a partial section along VI-VI of FIG. 2.

FIG. 7 is a diagram showing an assembly operation example of the connector.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure having a wire pulled out in a direction intersecting an extension direction of a terminal is provided with a first housing including a terminal accommodating portion formed with a terminal accommodation hole, the terminal being mounted into the terminal accommodation hole, and a wire accommodating portion extending outward from a part of an outer periphery of the terminal accommodating portion, and a second housing to be united with the first housing, the terminal accommodating portion and the wire accommodating portion being formed with a work opening open on a front side in a mounting direction of the terminal into the terminal accommodation hole, an outer end part of the wire accommodating portion being formed with a wire pull-out opening continuous with the work opening, the second housing including a lid portion for closing the work opening and a wire guiding end portion for guiding the wire pulled out from the terminal via the wire accommodating portion outside the wire pull-out opening, and an elastic ring arranged obliquely to an extension direction of the wire accommodating portion to be located closer to the terminal accommodating portion than the work opening and the wire pull-out opening being interposed between the first housing and the second housing.

According to this connector, the second housing includes the wire guiding end portion. Thus, as compared to the case where the first housing is formed with the wire guiding end portion, the wire freely moves during the insertion of the terminal and the terminal is easily inserted while the pull-out of the wire is reduced. Further, the work opening and the wire pull-out opening are continuous. Thus, after the terminal is inserted, utilizing the work opening, the wire can be easily arranged in the wire pull-out opening. In a united state of the first and second housings, water cut-off between the first and second housings can be easily realized by the elastic ring arranged obliquely to the extension direction of the wire accommodating portion to be located closer to the terminal accommodating portion than the work opening and the wire pull-out opening between the first and second housings.

(2) In the connector of (1), the wire accommodating portion may include a bottom portion and a pair of side wall portions rising from both sides of the bottom portion, the second housing may include a pair of inner wall portions rising from both sides of the lid portion, and the pair of inner wall portions may overlap inner sides of the pair of side wall portions.

In this case, during and after the insertion of the terminal, the wire is easily arranged between the pair of side wall portions. In this way, the wire is hardly caught by another part.

(3) In the connector of (2), the inner wall portion may include an inclined edge having a projecting dimension from the lid portion reduced with distance from the wire guiding end portion, an inclined step portion facing the inclined edge may be formed on the inner side of the side wall portion, and the elastic ring may be interposed between the inclined edge and the inclined step portion.

In this way, a configuration for obliquely arranging the elastic ring is easily realized. Since being arranged inside parts of the pair of side wall portions closer to tip sides than the inclined step portion, the elastic ring is hardly shifted in position.

(4) In the connector of (3), the inner wall portion may include a positioning extended edge projecting from an inner side of the inclined edge and located on an inner peripheral side of the elastic ring.

The position shift of the elastic ring is suppressed by this positioning extended edge.

(5) In the connector of any one of (2) to (4), the bottom portion may include a guiding inclined surface inclined toward a back side in the mounting direction of the terminal into the terminal accommodation hole as extending toward the outer end part of the wire accommodating portion.

In this way, the wire pulled out from the terminal toward the front side in the mounting direction is stably guided along a path along the guiding inclined surface in the wire accommodating portion.

(6) In the connector of any one of (2) to (5), the wire guiding end portion may be formed into a tubular shape, the lid portion and the pair of inner wall portions may be shaped to extend from one end part of the wire guiding end portion, and the connector may further comprise a wire waterproof portion interposed in a water cut-off state between an inner peripheral surface of the wire guiding end portion and an outer peripheral surface of the wire passing inside the wire guiding end portion.

In this way, the entrance of water along the wire into the second housing is suppressed by the wire waterproof portion. Further, water is cut off between the first and second housings by the elastic ring. Thus, the housings are effectively waterproofed behind the terminal.

(7) In the connector of (6), an interference avoiding groove partially recessed on an extension of the wire passed through the wire waterproof portion may be formed in an inner surface of the inner wall portion.

In this way, the wire can be guided to the inside of the inner wall portion by the interference avoiding groove when the inner wall portion is located on an extension of a wire holding path by the wire waterproof portion.

(8) In the connector of any one of (1) to (7), the first housing may include a first direction locking portion and a second direction locking portion, the second housing may include a first direction mating locking portion to be locked to the first direction locking portion and a second direction mating locking portion to be locked to the second direction locking portion, a first locking direction of the first direction locking portion and the first direction mating locking portion may be the extension direction of the terminal, and a second locking direction of the second direction locking portion and the second direction mating locking portion may be the extension direction of the wire accommodating portion.

By pressing the second housing against the first housing from two different directions in this way, the first and second housings can be firmly fixed. Further, the elastic ring can be effectively held in a compressed state and water cut-off property can be improved.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

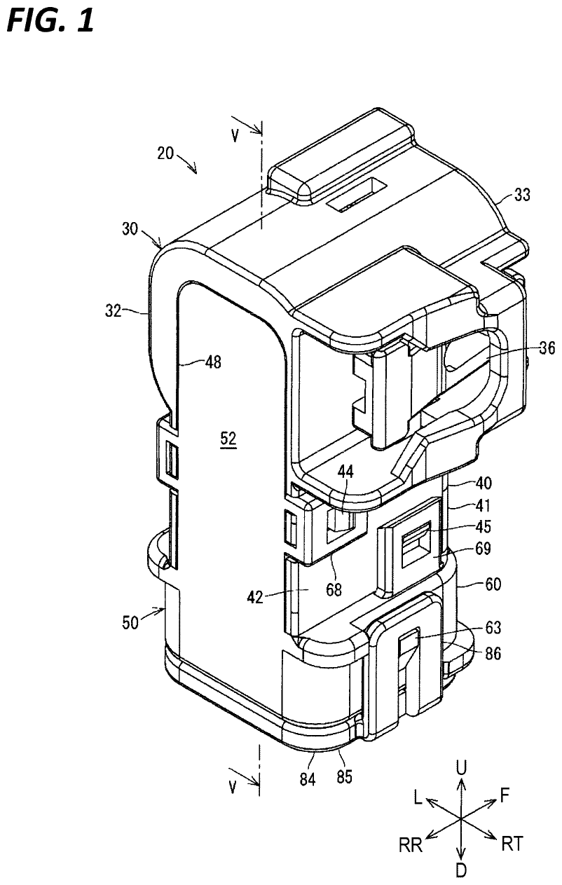

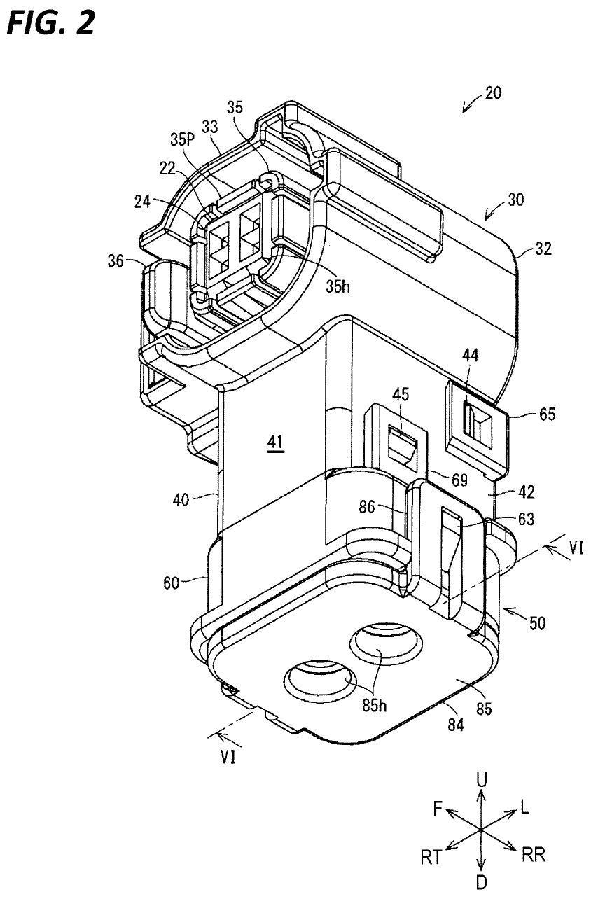

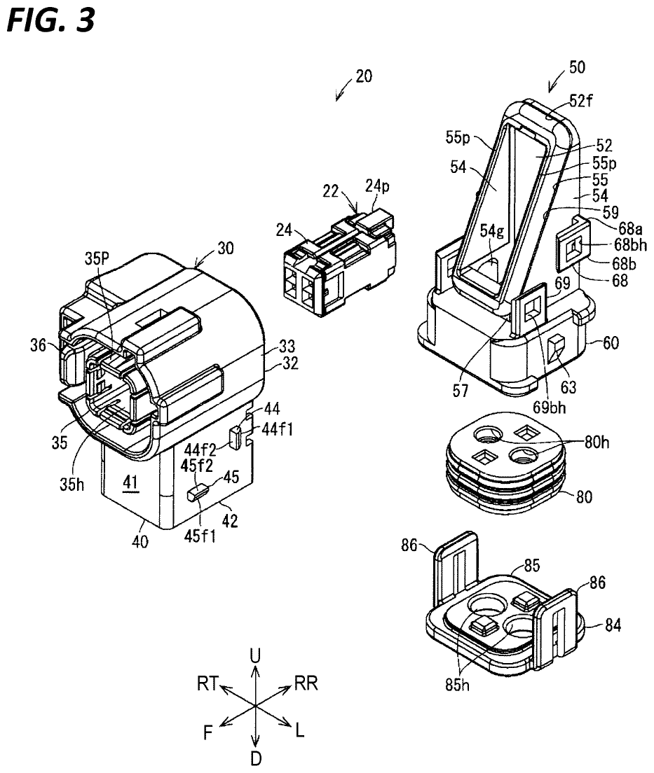

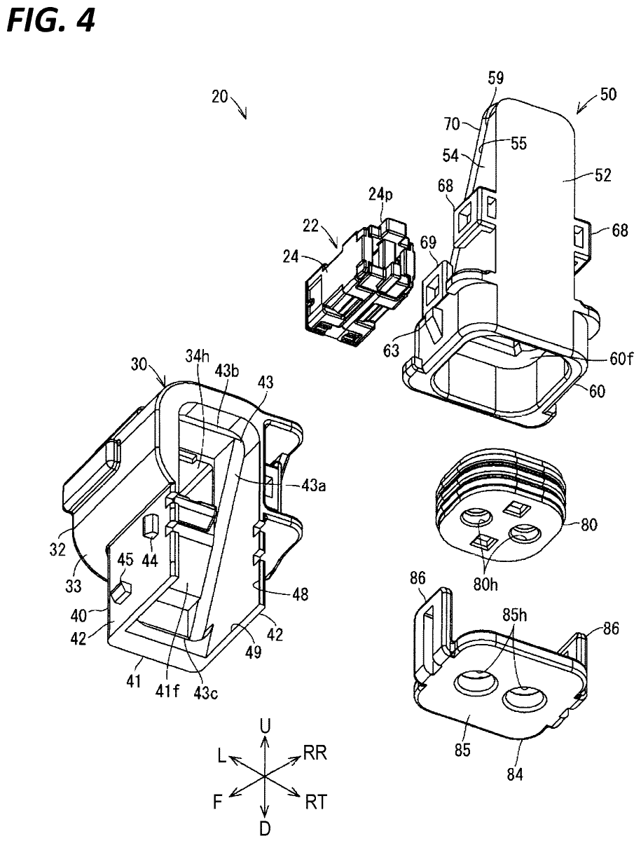

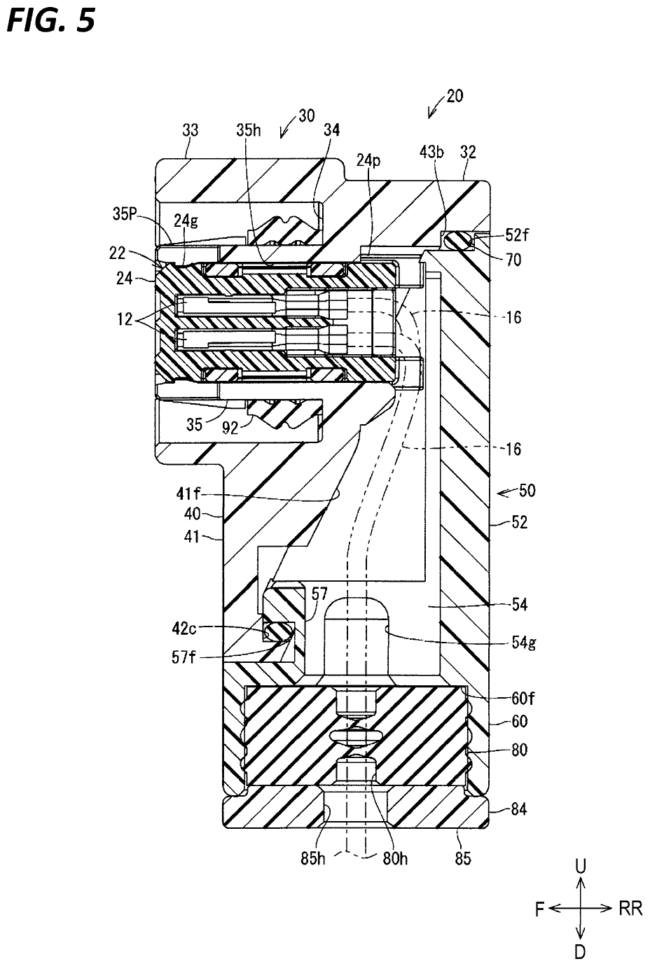

Hereinafter, a connector according to an embodiment is described. FIGS. 1 and 2 are perspective views showing a connector 20. FIGS. 3 and 4 are exploded perspective views showing the connector. FIG. 5 is a section along V-V of FIG. 1.

### <Overall Structure>

The overall structure of the connector 20 is described. In the connector 20, wires 16 are pulled out in a direction intersecting an extension direction of terminals 12 (see FIG. 5).

The connector 20 is provided with a first housing 30 and a second housing 50. A housing, which holds the terminals 12 and from which the wires 16 are pulled out in a predetermined direction, is configured by uniting the first and second housings 30, 50.

The first housing 30 is a molded product from resin or the like and provided with a terminal accommodating portion 32 and a wire accommodating portion 40.

The terminal accommodating portion 32 is a part formed with a terminal accommodation hole 35h, into which the terminals 12 are mounted. In this embodiment, the terminal accommodating portion 32 accommodates the terminals 12 by accommodating a terminal core unit 22 (see FIGS. 3 to 5).

The terminal core unit 22 includes the terminals 12 and a terminal holder 24 for holding the terminals 12. The terminal 12 is a component formed, such as by press-working a metal plate, and includes a wire connecting portion and a mating terminal connecting portion. The wire connecting portion and the mating connecting portion are, for example, linearly connected. The wire connecting portion in one end part of the terminal 12 is connected to an end part of the wire 16 by crimping or the like. The mating connecting portion is, for example, formed into a tubular shape, and a pin-like or tab-like male connecting portion of a mating terminal is inserted and connected to the mating connecting portion.

The terminal holder 24 is a resin component for holding the terminals 12. For example, the terminal core unit 22 includes a plurality of the terminals 12. The terminal holder 24 holds the plurality of terminals 12 in a predetermined array while insulating the plurality of terminals 12 from each other. For example, the terminal holder 24 may be a member obtained by uniting a holder body including cavities for holding the terminals 12 and a retainer for pressing the terminals 12 in the cavities. With the plurality of terminals 12 held by the terminal holder 24, the terminal holder 24 is held in the terminal accommodating portion 32 of the first housing 30. In this way, the plurality of terminals 12 are easily held in the predetermined array in the first housing 30.

The terminal accommodating portion 32 holds the terminals 12 inside by holding the terminal holder 24 inside. With the terminals 12 held in the terminal accommodating portion 32, the mating connecting portions are facing toward one end side of the terminal accommodating portion 32. A mating connector is connected to one end part of the terminal accommodating portion 32.

The wires 16 extend from the terminals 12 in the terminal accommodating portion 32 to the other end side of the terminal accommodating portion 32. The wire accommodating portion 40 extends outward from a part of the outer periphery of the terminal accommodating portion 32. The extension direction of the terminals 12 and that of the wire accommodating portion 40 intersect. The wires 16 extending from the terminals 12 are guided into the wire accommodating portion 40 through the other end part of the terminal accommodating portion 32 and pulled out to the outside of the wire accommodating portion 40. Thus, the wires 16 are pulled out in a direction different from the extension direction of the terminals 12.

The terminal accommodating portion 32 and the wire accommodating portion 40 are formed with a work opening 48 used to mount the terminals 12 and the wire 16. Further, the wire accommodating portion 40 is formed with a wire pull-out opening 49 used to pull out the wires 16.

The second housing 50 is a molded product from resin or the like and can be united with the first housing 30. By uniting the second housing 50 with the first housing 30, the work opening 48 is closed. Further, the second housing 50 includes a wire guiding end portion 60. By uniting the second housing 50 with the first housing 30, the wires 16 are guided and held at a position outside the wire pull-out opening 49 by the wire guiding end portion 60.

In the following description, a side where the mating connector is connected to the terminal accommodating portion 32 and an opposite side thereof may be referred to as a front side and a rear side. Further, a side where the wire accommodating portion 40 is located with respect to the terminal accommodating portion 32 and an opposite side thereof may be referred to as a lower side and an upper side. Further, left and right sides may be referred to in a state facing forward based on that vertical direction.

The structure of each component is more specifically described.

### <First Housing>

The first housing 30 is provided with the terminal accommodating portion 32 and the wire accommodating portion 40.

In this embodiment, the terminal accommodating portion 32 includes an outer tube portion 33. The outer tube portion 33 is, for example, in the form of a rectangular tube with rounded corners. A partitioning portion 34 is formed in an axially intermediate part of the outer tube portion 33. An inner tube portion 35 extends forward from the partitioning portion 34. An annular gap is formed between the inner peripheral surface of the outer tube portion 33 and the inner peripheral surface of the inner tube portion 35. Thus, one end part of the terminal accommodating portion 32 is formed into a double tube shape.

By connecting the mating connector to a front end part of the terminal accommodating portion 32 accommodating the terminal holder 24, mating terminals of the mating connector are connected to the terminals 12 in the inner tube portion 35.

The rear end of the inner tube portion 35 is open in the rear surface of the partitioning portion 34. By pushing the terminal holder 24 into the terminal accommodating portion 32 through this opening, the terminal holder 24 is accommodated and held in the terminal accommodating portion 32. A space surrounded by the inner peripheral surface of the inner tube portion 35 is the terminal accommodation hole 35h.

The positioning of the terminal holder 24 in the terminal accommodation hole 35h is, for example, realized by the following configuration. That is, a holder locking piece 35p including a protrusion is formed on the front end of the inner tube portion 35 (see FIGS. 2, 3 and 5). With the terminal holder 24 inserted in the terminal accommodation hole 35h, the protrusion of the holder locking piece 35P is retained and locked to a recess 24g of the terminal holder 24, whereby the terminal holder 24 is restricted from coming out rearward from the terminal accommodation hole 35h (see FIG. 5).

Further, a protrusion 24p (see FIG. 3) projecting outward from a rear end part of the terminal holder 24 contacts the edge of a rear opening of the terminal accommodation hole 35h, whereby the terminal holder 24 in the terminal accommodation hole 35h is restricted from moving forward.

A position restricting structure of the terminal holder 24 in the terminal accommodation hole 35h is arbitrary. For example, the position may be restricted by press-fitting the terminal holder 24 into the terminal accommodation hole 35h or may be restricted by sandwiching the terminal holder 24 between the first and second housings 30, 50 in the front-rear direction.

The outer tube portion 33 extends further rearward than the partitioning portion 34. A rear side of the outer tube portion 33 is open, and the rear opening of the inner tube portion 35 is open rearward through the rear opening of the outer tube portion 33. A part of the outer tube portion 33 connected to the wire accommodating portion 40 is open toward the inside of the wire accommodating portion 40.

The outer tube portion 33 may be formed with a lock piece 36 for maintaining a connected state to the mating connector.

The wire accommodating portion 40 extends outward from a part of the outer periphery of the terminal accommodating portion 32. Here, the wire accommodating portion 40 extends further downward from the bottom of a part of the terminal accommodating portion 32 near a rear end.

A part of the wire accommodating portion 40 connected to the terminal accommodating portion 32 communicates with a rear space in the terminal accommodating portion 32. A rear side and an outer side (lower side) of the wire accommodating portion 40 are open.

More specifically, the wire accommodating portion 40 includes a bottom portion 41 and a pair of side wall portions 42. The bottom portion 41 extends downward from an intermediate part in the front-rear direction of the terminal accommodating portion 32. An outward facing surface of the bottom portion 41 is formed into a rectangular shape orthogonal to the extension direction of the terminals 12. The pair of side wall portions 42 extend rearward from both left and right sides of the bottom portion 41. Outward facing surfaces of the pair of side wall portions 42 are formed into a rectangular shape.

A space surrounded by the bottom portion 41 and the pair of side wall portions 42 is continuous with the rear space in the terminal accommodating portion 32. Thus, the wires 16 pulled out into the rear space of the terminal accommodating portion 32 can be introduced into the wire accommodating portion 40.

An opening is formed on a side of the pair of side wall portions 42 opposite to the bottom portion 41, and this opening is continuous with the rear opening of the terminal accommodating portion 32. A rectangular opening present behind the terminal accommodating portion 32 and the wire accommodating portion 40 is the work opening 48 open on a front side in a mounting direction of the terminals 12 into the terminal accommodation hole 35h.

The space surrounded by the bottom portion 41 and the pair of side wall portions 42 is also open on a side (lower side) opposite to the terminal accommodating portion 32. This opening is the wire pull-out opening 49 continuous with the work opening 48 in an outer end part of the wire accommodating portion 40. Since the work opening 48 and the wire pull-out opening 49 are continuous, even if the wires 16 are passed through the work opening 48 during the mounting operation of the terminals 12, paths of the wires 16 can be changed to pass through the wire pull-out opening 49.

Inclined step portions 43a are formed inside the pair of side wall portions 42 (see FIG. 4). The inclined step portion 43a is a part facing an inclined edge 55 to be described later. Here, the inclined step portion 43a is inclined to be gradually closer to the work opening 48 toward the outer side of the wire accommodating portion 40 inside the side wall portion 42. Each of the pair of side wall portions 42 is formed with the inclined step portion 43a. One ends of a pair of the inclined step portions 43a pass along the inner side surfaces of a rear part of the terminal accommodating portion 32 and reach the upper edge of the work opening 48. The one ends of the pair of inclined step portions 43a are coupled by an elongated surface 43b along the upper edge of the work opening 48. The other ends of the pair of inclined step portions 43a extend toward the front end edge of the wire pull-out opening 49. The other ends of the pair of inclined step portions 43a are coupled by an elongated surface 43c along the front edge of the wire pull-out opening 49. The surfaces 43b, 43c are facing rearward and continuous with surfaces of the pair of inclined step portions 43a facing obliquely rearward. A rectangular annular receiving surface 43 is formed by the pair of inclined step portions 43a and the surfaces 43b, 43c. When seen through the side surface, the rectangular annular receiving surface 43 is inclined from the upper edge of the work opening 48 toward the front edge of the wire pull-out opening 49. When viewed from behind, the rectangular annular receiving surface 43 is inside and along the peripheral edge of the work opening 48. When viewed from below, the rectangular annular receiving surface 43 is inside and along the peripheral edge of the wire pull-out opening 49.

An inward facing surface of the bottom portion 41 includes a guiding inclined surface 41f inclined toward a back side in the mounting direction of the terminals 12 into the terminal accommodation hole 35h as extending toward an outer end part of the wire accommodating portion 40. In this embodiment, the guiding inclined surface 41f is parallel to the inclined step portions 43a. The guiding inclined surface 41f can function to guide a passage path of the wires 16 between the first and second housings 30, 50. Note that it is not essential that the inward facing surface of the bottom portion 41 includes the guiding inclined surface 41. For example, the inward facing surface of the bottom portion 41 is formed into a surface perpendicular to the extension direction of the terminals 12.

Further, the first housing 30 includes first direction locking portions 44 and second direction locking portions 45. The first direction locking portions 44 and the second direction locking portions 45 are, for example, formed on the respective outer side surfaces of the pair of side wall portions 42.

The first direction locking portions 44 and the second direction locking portions 45 are parts, to which mating locking portions are lockable from different directions.

Here, the first direction locking portion 44 is a part, to which the mating locking portion is lockable along the front-rear direction. More specifically, the first direction locking portion 44 is a protrusion formed on a part near a rear end, out of the outward facing surface of the side wall portion 42. The first direction locking portion 44 includes a guide surface 44f1 having a projecting dimension gradually reduced toward the rear side and a retaining surface 44f2 facing forward. A first direction mating locking portion 68 to be described later can ride over the guide surface 44f1 and be retained and locked to the retaining surface 44f2 by moving forward from the rear side.

Further, the second direction locking portion 45 is a part, to which the mating locking portion is lockable along the front-rear direction. More specifically, the second direction locking portion 45 is a protrusion formed on a part near a lower end, out of the outward facing surface of the side wall portion 42. The second direction locking portion 45 includes a guide surface 45f1 having a projecting dimension gradually reduced to the rear side and a retaining surface 45f2 facing forward. A second direction mating locking portion 69 to be described later can ride over the guide surface 45f1 and be retained and locked to the retaining surface 45f2 by moving upward from the lower side.

### <Second Housing>

The second housing 50 closes the work opening 48 and guides the wires 16 at the position outside the wire pull-out opening 49 by being united with the first housing 30. The second housing 50 includes a lid portion 52 and the wire guiding end portion 60.

The lid portion 52 is shaped to close the work opening 48. In this embodiment, the lid portion 52 is formed into a rectangular plate for closing the work opening 48 by being arranged in the work opening 48. A guiding inclined surface inclined in the same direction as the guiding inclined surface 41f and facing the guiding inclined surface 41f may be formed on an inner part of the lid portion 52. If the bottom portion 41 is formed with the guiding inclined surface 41f and the lid portion 52 is also formed with the guiding inclined surface, the wires 16 are restricted in the connector to be more reliably arranged at fixed positions. Note that the guiding inclined surface 41f of the bottom portion 41 may be omitted and the lid portion 52 may be formed with the guiding inclined surface.

Further, the second housing 50 includes a pair of inner wall portions 54 rising from both sides of the lid portion 52. The pair of inner wall portions 54 are arranged to overlap inner sides of the pair of side wall portions 42. For example, a distance between the outward facing surfaces of the pair of inner wall portions 54 is smaller than a distance between the inward facing surfaces of the pair of side wall portions 42 to such an extent that the pair of inner wall portions 54 can be arranged between the pair of side wall portions 42 without rattling. The pair of inner wall portions 54 extend upward beyond the pair of side wall portions 42 and reach the inner side surfaces of the rear part of the terminal accommodating portion 32.

The inner wall portion 54 includes the inclined edge 55 having a projecting dimension toward the bottom portion 41 reduced with distance from the wire guiding end portion 60. More specifically, the inner wall portion 54 is in the form of a right triangular plate. A part of the inner wall portion 54 corresponding to one of two sides across a right angle vertex is arranged along the rear edge of the inner wall portion 54, and a part corresponding to the other of the pair of sides across the right angle vertex is connected to the wire guiding end portion 60. A part corresponding to an oblique side of the inner wall portion 54 corresponds to the inclined edge 55.

Each of the pair of inner wall portions 54 includes the inclined edge 55. With the first and second housings 30, 50 united, a pair of the inclined edges 55 are arranged in parallel to the pair of inclined step portions 43a to face the pair of inclined step portions 43a.

One ends of the pair of inclined edges 55 reach the tip of the lid portion 52 and are continuous with a surface 52f along the tip of the lid portion 52. The other ends of the pair of inclined edges 55 are located at positions on a side of the wire guiding end portion 60 opposite to the lid portion 52. The other ends of the pair of inclined edges 55 are coupled by a coupling plate portion 57. The other ends of the pair of inclined edges 55 are continuous with an outward facing surface 57f of the coupling plate portion 57.

A rectangular annular pressing surface 59 is formed by end surfaces of the pair of inclined edges 55 and the surfaces 52f, 57f. The rectangular annular pressing surface 59 and the rectangular annular receiving surface 43 are arranged to face each other, and an elastic ring 70 is interposed between those.

The elastic ring 70 is an annular member made of an elastic material such as rubber. The elastic ring 70 is formed into a rectangular annular shape similar to the rectangular annular pressing surface 59. The elastic ring 70 is interposed between the rectangular annular pressing surface 59 and the rectangular annular receiving surface 43. In this way, the elastic ring 70 is arranged obliquely to an extension direction of the wire accommodating portion 40 to be located closer to the terminal accommodating portion 32 than the work opening 48 and the wire pull-out opening 49 between the first and second housings 30, 50.

The inner wall portion 54 includes a positioning extended edge 55p projecting from an inner side of the inclined edge 55 and located on an inner peripheral side of the elastic ring 70. Positioning extended edges are also present on inner sides of the surfaces 52f, 57f. Thus, a rectangular annular positioning extended edge is formed inside the rectangular annular pressing surface 59 inside the positioning extended edges 55p. The elastic ring 70 is arranged on the rectangular annular pressing surface 59 while being externally fit to this rectangular annular positioning edge.

The wire guiding end portion 60 is formed into a tubular shape connected to one end part of the lid portion 52. Here, the wire guiding end portion 60 is formed into a rectangular tube with rounded corners.

The wire guiding end portion 60 is continuous with a space between the lid portion 52 and the pair of inner wall portions 54. The wires 16 can pass through the inside of the wire guiding end portion 60 by way of the space between the lid portion 52 and the pair of inner wall portions 54. By being surrounded by the wire guiding end portion 60, the wires 16 can be guided and supported at the position outside the wire pull-out opening 49.

The lid portion 52 and the pair of inner wall portions 54 extend from one end part of the wire guiding end portion 60. More specifically, out of four wall portions of the wire guiding end portion 60, one is connected to the lid portion 52 and two are connected to the pair of inner wall portions 54. The remaining one wall portion of the wire guiding end portion 60 is arranged on an extension of the bottom portion 41.

The connector 20 is provided with a wire waterproof portion 80. The wire waterproof portion 80 is a part interposed in a water cut-off state between the inner peripheral surface of the wire guiding end portion 60 and the outer peripheral surfaces of the wires 16. In this embodiment, the wire waterproof portion 80 is made of an elastic material such as rubber. More specifically, the wire waterproof portion 80 is formed into a rectangular column with rounded corners. The outer peripheral surface of the wire waterproof portion 80 is shaped to be press-fittable into the wire guiding end portion 60. For example, an annular protrusion is formed on an outer peripheral part of the wire waterproof portion 80. Note that the wire waterproof portion 80 may be a water sealant or the like filled in the wire guiding end portion 60.

With the wire waterproof portion 80 press-fit in the wire guiding end portion 60, the wire waterproof portion 80 is in contact with a bottom surface 60f (see FIGS. 4 and 5) on the back side of the wire guiding end portion 60. In this state, the annular protrusion is pressed against the inner peripheral surface of the wire guiding end portion 60 entirely over a circumferential direction thereof. In this way, water is cut off between the wire waterproof portion 80 and the wire guiding end portion 60.

The wire waterproof portion 80 is formed with wire passage holes 80h, through which the wires 16 can be passed. With the wires 16 passed through the wire passage holes 80h, the inner peripheral surfaces of the wire passage holes 80h are in close contact with the outer peripheral surfaces of the wires 16. In this way, water is cut off between the wires 16 and the wire waterproof portion 80.

Since the wires 16 are introduced into the second housing 50 through the wire waterproof portion 80, the entrance of water from the side of the wire guiding end portion 60 of the second housing 50 is suppressed.

In this embodiment, the connector 20 is further provided with a water cut-off holder 84 for pressing the wire waterproof portion 80 against the wire guiding end portion 60. The water cut-off holder 84 is provided with a pressing plate portion 85 to be located in an outer opening of the wire guiding end portion 60 and a pair of locking pieces 86.

The pressing plate portion 85 is formed with holes 85h, through which the wires 16 can be passed. The pair of locking pieces 86 extend from both sides of the pressing plate portion 85 toward two outward facing side surfaces of the wire guiding end portion 60. Locking protrusions 63 are formed on the two outward facing surfaces of the wire guiding end portion 60.

By locking the locking protrusions 63 to the pair of locking pieces 86 with the wire waterproof portion 80 press-fit in the wire guiding end portion 60, the water cut-off holder 84 is attached to the wire guiding end portion 60. In this state, the pressing plate portion 85 is located in the outer opening of the wire guiding end portion 60 and the pressing plate portion 85 holds the wire waterproof portion 80 not to come out from the wire guiding end portion 60.

In this embodiment, the wire waterproof portion 80 is formed with a plurality of (here, two) the wire passage holes 80. When viewed along an axial direction of the wire passage hole 80h, the wire passage hole 80h and the inner wall portion 54 overlap. For example, it may be difficult to closely arrange the plurality of wire passage holes 80h and it may be required to arrange the plurality of wire passage holes 80h at a predetermined distance from each other due to a mold for forming the wire waterproof portion 80, the strength of the wire waterproof portion 80 and the like. In this case, if an interval between the pair of inner wall portions 54 is increased according to the distance between the plurality of wire passage holes 80h, the connector 20 is enlarged. If an attempt is made to reduce the interval between the pair of inner wall portions 54 regardless of the distance between the plurality of wire passage holes 80h, the wire passage holes 80h and the inner wall portions 54 possibly overlap as described above.

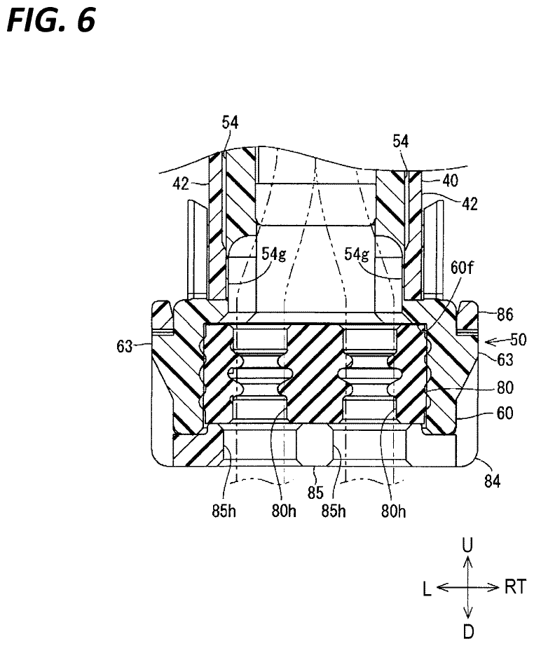

Accordingly, in this embodiment, an interference avoiding groove 54g partially recessed on an extension of the wire passage hole 80h is formed in the inner surface of the inner wall portion 54 (see FIG. 6). The interference avoiding groove 54g may be, for example, an arcuate groove. The interference avoiding groove 54g is formed between an end edge of the inner wall portion 54 on the side of the wire guiding end portion 60 and an intermediate part in an extension direction of the inner wall portion 54. The interference avoiding groove 54g may include a part gradually shallower on the way to a tip side. In this embodiment, a tip part of the interference avoiding groove 54g is shaped to be gradually shallower toward the tip side.

The wires 16 guided into the second housing 50 through the wire passage holes 80h are partially guided between the pair of inner wall portions 54 through the insides of the interference avoiding grooves 54g.

The second housing 50 includes the first direction mating locking portions 68 to be locked to the first direction locking portions 44 and the second direction mating locking portions 69 to be locked to the second direction locking portions 45.

The first direction mating locking portion 68 is formed on an edge near the lid portion 52, out of the outer surface of the inner wall portion 54. The first direction mating locking portion 68 includes a base portion 68a projecting from the outer surface of the inner wall portion 54 by a thickness of the side wall portion 42 and a locking piece 68b extending forward from the base portion 68a. The locking piece 68b is formed with a locking hole 68bh serving as a recess, into which the first direction locking portion 44 is lockable.

The second direction mating locking portion 69 is formed on a part of the wire guiding end portion 60 protruding further outward than the outer surface of the inner wall portion 54. The second direction mating locking portion 69 is in the form of a plate extending upward at a position separated from the outer surface of the inner wall portion 54 by the thickness of the side wall portion 42. The second direction mating locking portion 69 is formed with a locking hole 69bh serving as a recess, into which the second direction locking portion 45 is lockable.

Here, a relative moving direction when the locking portion and the mating locking portion are locked is referred to as a locking direction. The locking direction of the first direction locking portion 44 and the first direction mating locking portion 68 is the front-rear direction, which is the extension direction of the terminals 12. The first direction locking portion 44 and the first direction mating locking portion 68 are retained and locked in a direction not to be separated from each other in the front-rear direction, which is the extension direction of the terminals 12. The locking direction of the second direction locking portion 45 and the second direction mating locking portion 69 is the vertical direction, which is the extension direction of the wire accommodating portion 40. The second direction locking portion 45 and the second direction mating locking portion 69 are retained and locked in a direction not to be separated from each other in the vertical direction, which is the extension direction of the wire accommodating portion 40.

Thus, the elastic ring 70 between the rectangular annular receiving surface 43 and the rectangular annular pressing surface 59 is held in a compressed state in the extension direction of the terminals 12 and the extension direction of the wire accommodating portion 40.

### <Assembly Operation Example of Connector>

An assembly operation example of the connector 20 is described.

The first and second housings 30, 50 are prepared. The elastic ring 70 is set on the rectangular annular pressing surface 59 of the second housing 50. At this time, the elastic ring 70 may be externally fit to the rectangular positioning extended edge including the positioning extended edges 55p. The elastic ring 70 may be set on the side of the first housing 30.

Further, the terminal-equipped wires in which the terminals 12 are crimped to end parts of the wires 16 are prepared. The terminals 12 are set in the terminal holder 24 to assemble the terminal core unit 22. Further, the wires 16 are passed through the wire passage holes 80h of the wire waterproof portion 80. The wire waterproof portion 80 may be set in the wire guiding end portion 60.

Note that if four terminals 12 and two wire passage holes 80h are provided, it is, for example, assumed that two wires are formed into one cable by being covered by an outer sheath, the two cables are passed through the wire passage holes 80h and divided into four wires 16 in the connector, and the four wires 16 are connected to the four terminals 12.

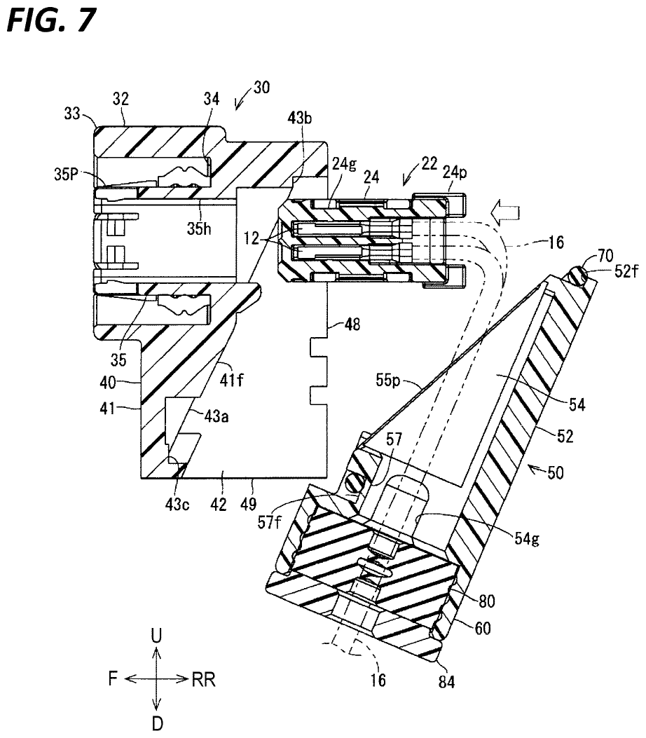

Then, as shown in FIG. 7, the terminal core unit 22 is moved to behind the terminal accommodating portion 32, utilizing the work opening 48, and pushed into the terminal accommodation hole 35h from behind. At this time, the wires 16 extend rearward from the terminal core unit 22 through the work opening 48 and are held by the wire guiding end portion 60 of the second housing 50.

Here, if rubber plugs are located at fixed positions with respect to a terminal insertion opening as before, it is assumed that wires are required to be largely pulled out behind the terminals for a terminal inserting operation.

In this embodiment, in an assembly stage, the position of the wire guiding end portion 60 of the second housing 50 can be changed with respect to the terminal accommodation hole 35h formed in the first housing 30. Thus, when the terminal core unit 22 is inserted into the terminal accommodation hole 35h, the position of the wire guiding end portion 60 can be adjusted according to the positions of the wires 16 extending rearward from the terminal core unit 22. For example, in a state before the terminal core unit 22 is inserted into the terminal accommodation hole 35h, the wires 16 are located more rearward than positions in an assembly completed state. Accordingly, in this state, the wire guiding end portion 60 is located behind the wire pull-out opening 49. Then, the wires 16 need not be largely pulled out between the terminal core unit 22 and the wire guiding end portion 60.

After the terminal core unit 22 is mounted into the terminal accommodation hole 35h, the second housing 50 is brought closer to the first housing 30 from the side of the work opening 48 and the wire pull-out opening 49. Since being arranged between the pair of inner wall portions 54, the wires 16 are hardly caught by or rubbed against the first housing 30 or the second housing 50. When the first and second housings 30, 50 are brought closer, the wires 16 extending from the wire waterproof portion 80 may be pulled outward if necessary. Also at this time, the wires 16 are hardly caught by or rubbed against another part since being arranged between the pair of inner wall portions 54.

By retaining and locking the first direction locking portions 44 and the second direction locking portions 45 to the first direction mating locking portions 68 and the second direction mating locking portions 69, the first and second housings 30, 50 are united. Then, the elastic ring 870 is interposed in the compressed state between the rectangular annular pressing surface 59 and the rectangular annular pressing surface 59.

In this state, water is cut off at a boundary between the first and second housings 30, 50 by the elastic ring 70. Even if water enters the first housing 30 through the work opening 48 or the wire pull-out opening 49, further entrance to the back is suppressed by the elastic ring 70. Further, the wire guiding end portion 60 of the second housing 50 communicates with a housing inner space cut off from water by the elastic ring 70. Thus, if the wire guiding end portion 60 is cut off from water by the wire waterproof portion 80, the entrance of water along the wires 16 is also suppressed. Therefore, the entire connector 20 is cut off from water.

Note that a part of the wire accommodating portion 40 on a side to be connected to the mating connector may be cut off from water by a water cut-off seal 92 on the outer periphery of the inner tube portion 35 in the connected state of the mating connector (see FIG. 5).

### <Effects, Etc.>

According to the connector configured as described above, the second housing 50 includes the wire guiding end portion 60. Thus, the wires 16 freely move during the insertion of the terminals 12 as compared to the case where the first housing 30 is formed with a part corresponding to the wire guiding end portion 60. Thus, the terminals 12, here the terminal core unit 22, are/is easily inserted while the pull-out of the wires 16 from the wire guiding end portion 60 is reduced. The assembly operation of the connector 20 is facilitated also because a wire pull-back operation can be reduced by reducing the pull-out amount of the wires 16 and attention to prevent the pull-out wires 16 from being caught can be reduced.

Further, the work opening 48 and the wire pull-out opening 49 are continuous. Thus, the wires 16 can be easily arranged in the wire pull-out opening 49 after the terminals 12 are inserted, utilizing the work opening 48. With the first and second housings 30, 50 united, water cut-off can be easily realized between the first and second housings 30, 50 by the elastic ring 70 arranged obliquely to the extension direction of the wire accommodating portion 40 to be located closer to the terminal accommodating portion 32 than the work opening 48 and the wire pull-out opening 49 between the first and second housings 30, 50.

Further, the wire accommodating portion 40 includes the bottom portion 41 and the pair of side wall portions 42, the second housing 50 includes the lid portion 52 and the pair of inner wall portions 54, and the pair of inner wall portions 54 overlap the inner sides of the pair of side wall portions 42. Thus, during and after the insertion of the terminals 12, the wires 16 are easily arranged between the pair of side wall portions 42 and hardly caught by or rubbed against another part.

The inner wall portions 54 include the inclined edges 55, the inclined step portions 43a are formed inside the side wall portions 42 and the elastic ring 70 is interposed between the inclined edges 55 and the inclined step portions 43a. Thus, a configuration for locking the elastic ring 70 in an oblique posture is easily realized. Further, the elastic ring 70 is arranged inside the parts of the pair of side wall portions 42 closer to the tip sides than the inclined step portions 43a. Thus, the elastic ring 70 is hardly shifted in position.

Further, since the inner wall portions 54 include the positioning extended edges 55p, the position shift of the elastic ring 70 is suppressed by the positioning extended edges 55p.

Further, since the bottom portion 41 includes the guiding inclined surface 41f, the wires 16 pulled out rearward toward the front side in the mounting direction of the terminals 12 are stably supported to extend gradually forward along the guiding inclined surface 41f in the wire accommodating portion 40. Thus, the wires 16 hardly move in the wire accommodating portion 40.

Further, the entrance of water along the wires 16 into the second housing 50 is suppressed by the wire waterproof portion 80. Water is cut off between the first and second housings 30, 50 by the elastic ring 70. Thus, the housings 30, 50 are effectively waterproofed behind the terminals 12.

Further, the inner wall portions 54 are formed with the interference avoiding grooves 54g. Thus, if the inner wall portions 54 are located on the extensions of the holding paths for the wires 16 by the wire waterproof portion 80, the wires 16 can be guided to the insides of the inner wall portions 54 by the interference avoiding grooves 54g. Even if there are restrictions on the formation positions of the wire passage holes 80h in the wire waterproof portion 80, the interval between the pair of inner wall portions 54 can be reduced, which can contribute to the size reduction of the connector 20.

Further, the first locking direction of the first direction locking portions 44 and the first direction mating locking portions 68 is the extension direction of the terminals 12, and the second locking direction of the second direction locking portions 45 and the second direction mating locking portion 69 is the extension direction of the wire accommodating portion 40. Thus, by pushing the second housing 50 against the first housing 30 from different directions, the both housings 30, 50 can be firmly fixed. Further, the elastic ring 70 can be held in the compressed state from the different directions and water cut-off property can be improved.

### [Modifications]

Note that the terminals 12 need not be held in the terminal accommodating portion 32 while being held by the terminal holder 24. For example, terminals may be directly inserted and held in terminal holding holes formed in a terminal accommodating portion.

Further, the number of terminals provided in a connector is arbitrary. For example, a first housing may hold only one terminal.

Note that the respective configurations described in the above embodiment and each modification can be appropriately combined without contradicting each other.

List of Reference Numerals

| 12 | terminal |
|---|---|
| 16 | wire |
| 20 | connector |
| 22 | terminal core unit |
| 24 | terminal holder |
| 24g | recess |
| 24p | protrusion |
| 30 | first housing |
| 32 | terminal accommodating portion |
| 33 | outer tube portion |
| 34 | partitioning portion |
| 35 | inner tube portion |
| 35P | holder locking piece |
| 35h | terminal accommodation hole |
| 36 | lock piece |
| 40 | wire accommodating portion |
| 41 | bottom portion |
| 41f | guiding inclined surface |
| 42 | side wall portion |
| 43 | rectangular annular receiving surface |
| 43a | inclined step portion |
| 43b, 43csurface | |
| 44 | first direction locking portion |
| 44f1, 45f1 | guide surface |
| 44f2, 45f2 | retaining surface |
| 45 | second direction locking portion |
| 48 | work opening |
| 49 | wire pull-out opening |
| 50 | second housing |
| 52 | lid portion |
| 52f, 57f | surface |
| 54 | inner wall portion |
| 54g | interference avoiding groove |
| 55 | inclined edge |
| 55p | positioning extended edge |
| 57 | coupling plate portion |
| 59 | rectangular annular pressing surface |
| 60 | wire guiding end portion |
| 60f | bottom surface |
| 63 | locking protrusion |
| 68 | first direction mating locking portion |
| 68a | base portion |
| 68b | locking piece |
| 68bh | locking hole |
| 69 | second direction mating locking portion |
| 69bh | locking hole |
| 70 | elastic ring |
| 80 | wire waterproof portion |
| 80h | wire passage hole |
| 84 | water cut-off holder |
| 85 | pressing plate portion |
| 85h | hole |
| 86 | locking piece |
| 92 | water cut-off seal |

1. A connector having a wire pulled out in a direction intersecting an extension direction of a terminal, comprising:
a first housing including a terminal accommodating portion formed with a terminal accommodation hole, the terminal being mounted into the terminal accommodation hole, and a wire accommodating portion extending outward from a part of an outer periphery of the terminal accommodating portion; and
a second housing to be united with the first housing,
the terminal accommodating portion and the wire accommodating portion being formed with a work opening open on a front side in a mounting direction of the terminal into the terminal accommodation hole,
an outer end part of the wire accommodating portion being formed with a wire pull-out opening continuous with the work opening,
the second housing including a lid portion for closing the work opening and a wire guiding end portion for guiding the wire pulled out from the terminal via the wire accommodating portion outside the wire pull-out opening, and
an elastic ring arranged obliquely to an extension direction of the wire accommodating portion to be located closer to the terminal accommodating portion than the work opening and the wire pull-out opening being interposed between the first housing and the second housing.

2. The connector of claim 1, wherein:
the wire accommodating portion includes a bottom portion and a pair of side wall portions rising from both sides of the bottom portion,
the second housing includes a pair of inner wall portions rising from both sides of the lid portion, and
the pair of inner wall portions overlap inner sides of the pair of side wall portions.

3. The connector of claim 2, wherein:
the inner wall portion includes an inclined edge having a projecting dimension from the lid portion reduced with distance from the wire guiding end portion,
an inclined step portion facing the inclined edge is formed on the inner side of the side wall portion, and
the elastic ring is interposed between the inclined edge and the inclined step portion.

4. The connector of claim 3, wherein the inner wall portion includes a positioning extended edge projecting from an inner side of the inclined edge and located on an inner peripheral side of the elastic ring.

5. The connector of claim 2, wherein the bottom portion includes a guiding inclined surface inclined toward a back side in the mounting direction of the terminal into the terminal accommodation hole as extending toward the outer end part of the wire accommodating portion.

6. The connector of claim 2, wherein:
the wire guiding end portion is formed into a tubular shape,
the lid portion and the pair of inner wall portions are shaped to extend from one end part of the wire guiding end portion, and
the connector further comprises a wire waterproof portion interposed in a water cut-off state between an inner peripheral surface of the wire guiding end portion and an outer peripheral surface of the wire passing inside the wire guiding end portion.

7. The connector of claim 6, wherein an interference avoiding groove partially recessed on an extension of the wire passed through the wire waterproof portion is formed in an inner surface of the inner wall portion.

8. The connector of claim 1, wherein:
the first housing includes a first direction locking portion and a second direction locking portion,
the second housing includes a first direction mating locking portion to be locked to the first direction locking portion and a second direction mating locking portion to be locked to the second direction locking portion,
a first locking direction of the first direction locking portion and the first direction mating locking portion is the extension direction of the terminal, and
a second locking direction of the second direction locking portion and the second direction mating locking portion is the extension direction of the wire accommodating portion.
